(19) United States
(12) Patent Application Publication
(10) Pub. No.: US 2023/0026239 A1
(43) Pub. Date: Jan. 26, 2023

(54) BAG GRIPPER

(71) Applicant: Quinn Fowler, Ivins, UT (US)

(72) Inventor: Quinn Fowler, Ivins, UT (US)

(21) Appl. No.: 17/873,412

(22) Filed: Jul. 26, 2022

Related U.S. Application Data
(60) Provisional application No. 63/225,765, filed on Jul. 26, 2021.

(51) Int. Cl. B65F 1/06

(52) U.S. Cl. CPC B65F 1/065

(57) ABSTRACT

A bag gripper for securing a trash bag to a trash can. According to one embodiment the bag gripper comprises a front wall, side wall and back wall with a thickness that define a hollow chamber. The front wall has at number of slits that define one or more tabs. In another embodiment the side wall has a groove with a first and second surface, and the back wall has a hole whose perimeter aligns with the interior of the side wall. In another embodiment the bag gripper is part of a trash can. In another embodiment the bag gripper is integral with a trash can.

### CROSS REFERENCE TO RELATED APPLICATIONS

The present application claims the benefit under 35 U. S.C. 119 of U.S. Provisional Patent Application Ser. No. 63/225,765 filed Jul. 26, 2021. The U.S. Provisional Patent Application Ser. No. 63/225,765 is hereby incorporated by reference in its entirety.

### FIELD OF THE INVENTION

The present specification relates generally to devices for securing a can liner within a can and more specifically for such devices that are mounted to a can.

### BACKGROUND OF THE INVENTION

It is common to place a trash can liner, or trash bag on the inside of a trash can to receive garbage and other items. Conventionally, a top edge of the bag is folded over the rim of the can. This helps to protect the can from being soiled by discarded trash, particularly food particles, which can spoil and attract unwanted pests and disease, as well as emit unwanted odors. Folding the bag over the can rim is also an attempt to keep the bag from sliding down into the can as it is filled.

Both trash cans and trash can liners come in a variety of sizes and the liners seldom fit perfectly and snuggly onto the can. If the bag is too small, the top edge cannot be draped over the can rim. If the bag is too large, the bag tends to fall into the can even though it has been folded over the rim of the can. When this happens, not only can the discarded trash spill out of the bag, but one must physically grab the top edge of the bag, pull it up, and re-fold it over the can rim.

One method of preventing the bag from falling into the can is to tie a knot in a strip formed of a portion of the bag top edge to effectively reduce the diameter of the bag opening so that the bag top edge can be snuggly folded over the can rim. Unfortunately, this method requires a level of manual dexterity and necessitates untying the knot when the bag must be removed and tied shut.

Another method is the use of clips to secure the folded edge of the can liner to the rim of the can. This method requires extra time to remove and attach the clips. Also, the clips can be dropped, fall into dirty refuse, brake or lost.

Another method is the use of rubber bands to secure the bag to the can. However, this method is specific for a certain size of can, so multiple sizes of bands would need to be available. Also, the bands can break, as well as be dropped or lost increasing the cost of use when they are replaced, and time to empty the trash.

Therefore, there is a need for a trash can that incorporates a bag gripper on the trash can or a device that can be placed easily on the trash can to hold the bag securely with the need for any completed steps.

### BRIEF SUMMARY OF THE INVENTION

Accordingly, the present bag gripper has been made in view of the above-mentioned disadvantages occurring in the prior art. Some advantages of this bag gripper are that it cannot fall into the refuse, cannot be lost, and will be useful with multiple sizes of bags and cans.

A bag gripper is comprised of a body that has a front wall, a back wall, and at least one side wall which define a hallow chamber. The front wall has at least one slit, which defines two tabs. The front wall preferably has at least 2 slits, which intersect at an intersection point to define at least 4 tabs but can have more or fewer slits which define more or fewer tabs. The tabs can be configured to grip a thin material, such as a trash can liner. The intersection point can be at the substantial center of the slit. The intersection point can be at the substantial center of the front wall. The exterior of the back wall can have an adhesive with or without a removable backing.

The front wall can be made from a flexible and durable material, such as, rubber, nylon, plastic, or the like. It can be circular, elliptical, square, hexagonal, octagonal, dodecagonal, or the like. The slits in the front wall can be configured to grip a thin material, such as a trash can liner. The front wall, side wall, and back wall can be integral or separate, or any combination of integral and separate. The bag gripper can further comprise a groove in the side wall. The groove having a first surface and a second surface. Either, both, or none of the first and second surfaces can have an adhesive. The adhesive can or not have a removable backing. The bag gripper back wall can have a hole, wherein the hole's perimeter aligns with the interior of the side wall.

The bag gripper can be part of a can wherein the bag gripper is installed such that the first surface and second surface sandwich the side of the can. The can may be a trash can, or the like. The bag gripper can be integral to a can comprising a bottom and at least one side wherein the at least one side contains at least two slits which intersect at an intersection point and define at least four tabs but can have more or fewer slits defining more or fewer tabs. The at least four tabs narrow from the side of the can to the intersection point. The at least one can side is made of flexible and durable materials, such as, rubber, nylon, plastic, or the like. The tabs can be configured to grip a thin material, such as a trash can liner, or the like.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isomeric view of a bag gripper in accordance to one, or more embodiments;

FIGS. 2a and 2b and is a cross-sectional view and side view of a bag gripper in accordance to one, or more embodiments;

FIG. 3 is a cross section view of an embodiment of a bag gripper on a can in accordance to one, or more embodiments;

FIG. 4 is an isomeric top view of another embodiment of a bag gripper in accordance to one, or more embodiments;

FIGS. 5a and 5b are cross sectional and side view of a bag gripper in accordance to one, or more embodiments;

FIG. 6 is a profile view of an embodiment of a can with a bag gripper in accordance to one, or more embodiments;

FIG. 7 is a side view of another embodiment of a bag gripper integral with a can in accordance to one, or more embodiments;

FIG. 7a is a close cross sectional view of an embodiment of an integral bag gripper;

FIG. 8 is an embodiment of a bag gripper in accordance to one, or more embodiments; and

FIG. 9 is front view of an embodiment of a bag gripper in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

A bag gripper is a device that can grip a trash can liner that can hold the trash can liner in place while it is folded over the top of a trash can, allowing for quick and clean trash can liner changes. The bag gripper can be attached to a trash can, or it can be integral with the trash can which eliminates the possibility of the gripper becoming lost or soiled by falling into the refuse.

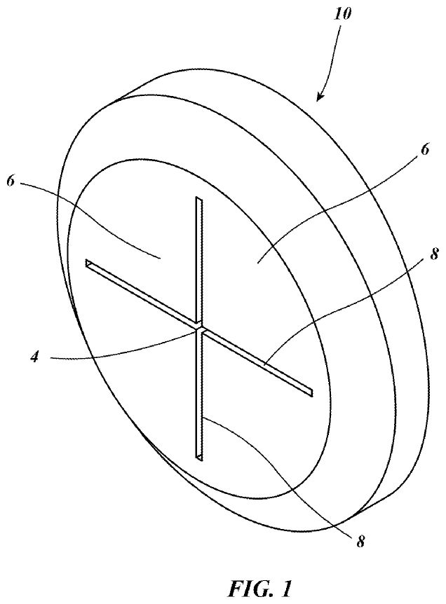

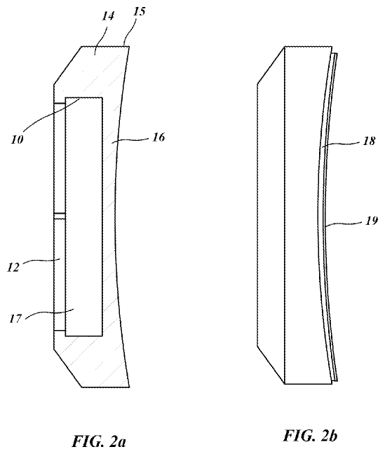

Referring initially to FIG. 1 through 2b, an embodiment of a bag gripper shown generally at 10. The bag gripper 10 can comprise a front wall 12, a back wall 16, and at least one side wall 14 wherein the front wall 12, back wall 16, and side wall 14 can form one complete piece. The front wall 12 can be any shape, such as, for example, circular, elliptical, triangular, square, hexagonal, heptagonal, octagonal, dodecagonal, or the like. The front wall 12, side wall 14, and back wall 16 each have a thickness and can define a hollow chamber 17. The hollow chamber 17 can extend from the front wall 12 to the back wall 16 defining the front wall and side wall 14 thickness. The hollow chamber 17 can be any shape, such as circular, elliptical, triangular, or the like or it can be the same shape as the front wall 12 and the back wall 16. In certain embodiments, the hollow chamber 17 can extend partially or fully through the back wall 16.

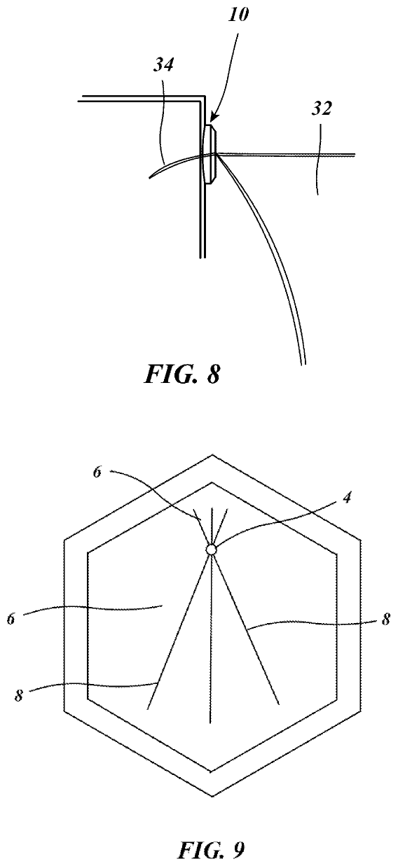

The front wall 12 has at least one slit 8 which defines at least two tabs 6. Preferably, the front wall 12 has at least two slits 8 which intersect at an intersection point 4, which can define at least four tabs 6, but the slit can have more than two slits or one slit which can define the number of tabs on the front wall 12. The intersection point 4 can be in the approximate center of a slit, or it can be off-centered towards an end, or any combination of centered and off-centered as shown in FIG. 9. The intersection point 4 can be substantially centered on the front wall 12, or the intersection point can be off center. The tabs 6 can be configured to grip a thin material, such as, for example, a trash can liner fabric, sheet of plastic, plastic bag, small rope, and the like. The tabs 6 can be thin walled wherein the tabs can bend, but not break when they are pushed on by the user. In other embodiments, the tabs 6 can be thick-walled material wherein the tabs will only bend when sufficient force is pushed against them to allow a portion of a bag into the hollow chamber 17. The side wall 14 can be straight, or it can be sloped, or it can be any combination of straight and sloped.

The back wall 16 can be flat, or it can be curved to conform to the shape of another object, such as a conventional garbage can. The back wall 16 can also have an adhesive 18 applied to it, allowing the bag gripper 10 to be attached to another object, such as, for example, a conventional garbage can, a waste basket, a bedpan, a metal container, a plastic or metal drum, a table, a cabinet, or the like. The adhesive (not shown) can be a glue, tape, polyimide, epoxy, polyurethane, paste, liquid, film, or the like, or any combination thereof. The adhesive can have a removable backing 19 to protect the adhesive before it is attached to the other object.

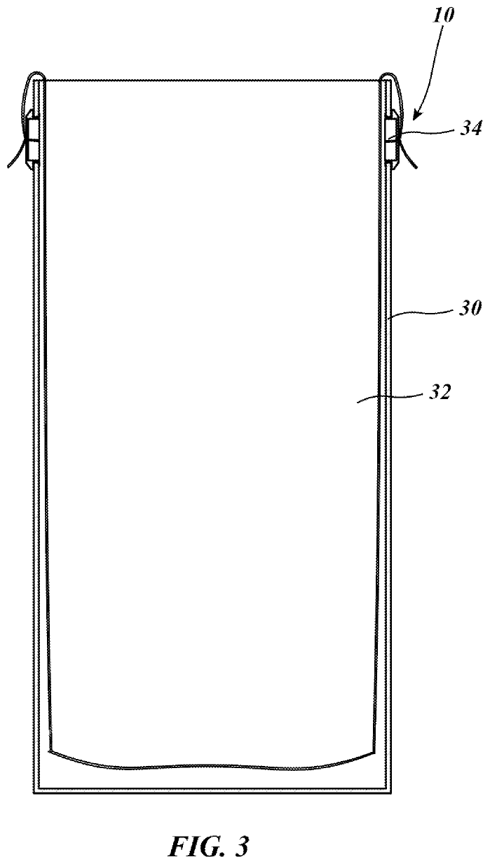

Referring now to FIG. 3, shows an example usage of the trash liner attaching to the bag gripper 10 attached to a can 30 wherein the can be such as, for example, garbage can, dustbin, wastebasket, ash bin, trash barrel, dumpster, or the like. The excess liner 34 is gathered around the top of the can 30, cinching the liner around the can. The excess liner 34 is then pushed through the slits 8, shown in FIG. 1, of the bag gripper 10, and into the hollow chamber 17. The bag gripper 10 holds the excess liner 34 keeping a liner 32 cinched around the can, preventing the liner 32 from falling into the can, preventing the liner from becoming soiled with refuse, preventing the refuse from escaping the liner and soiling the can, and allowing the use of multiple bag sizes for a single can. When the liner 32 is ready to be removed the excess liner 34 is gently pulled from the bag gripper 10 and the liner is removed from the trash can 30. Since the gripper 10 can be adhered to the trash can, it will not fall into the refuse. The liner 32 can be such as, for example, a trash bag, trash can liner, bin bag, or the like which can be plastic, rubber, or the like. Additionally, the bag gripper 10 will not become lost since it is not necessary to remove the bag gripper in order to remove the bag, allowing for quick removal and/or replacement of a trash can liner.

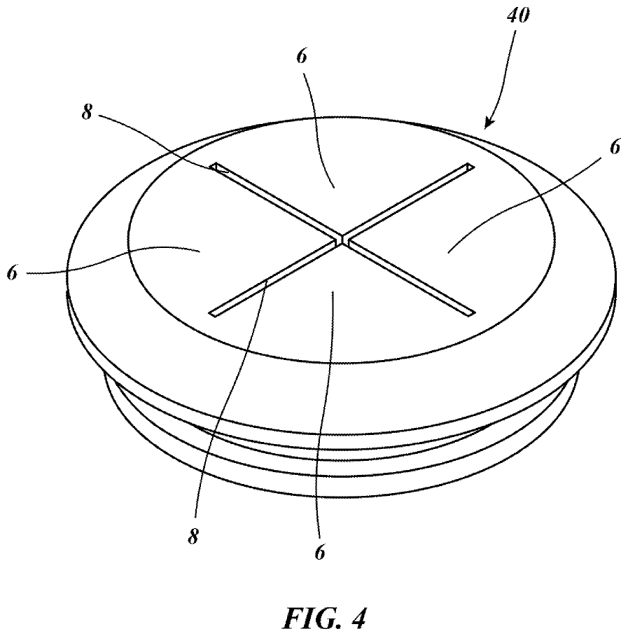

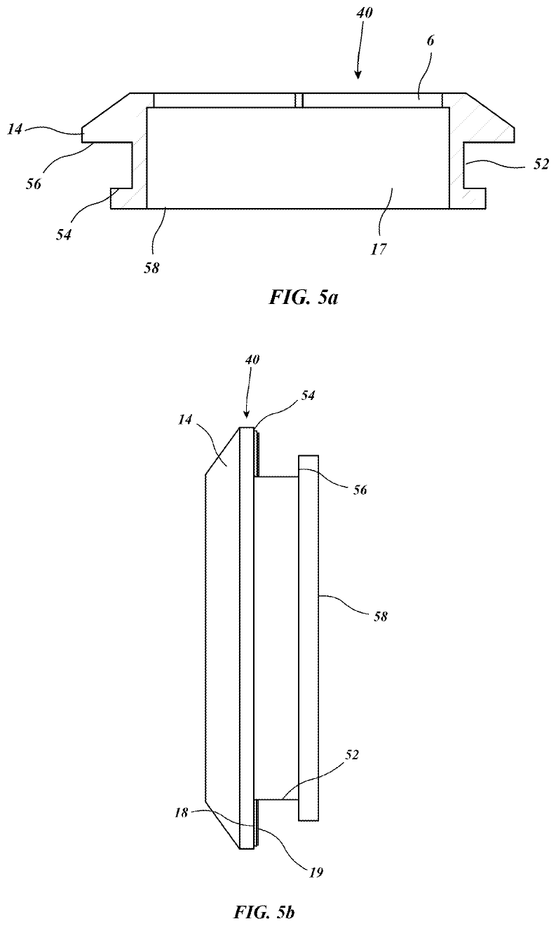

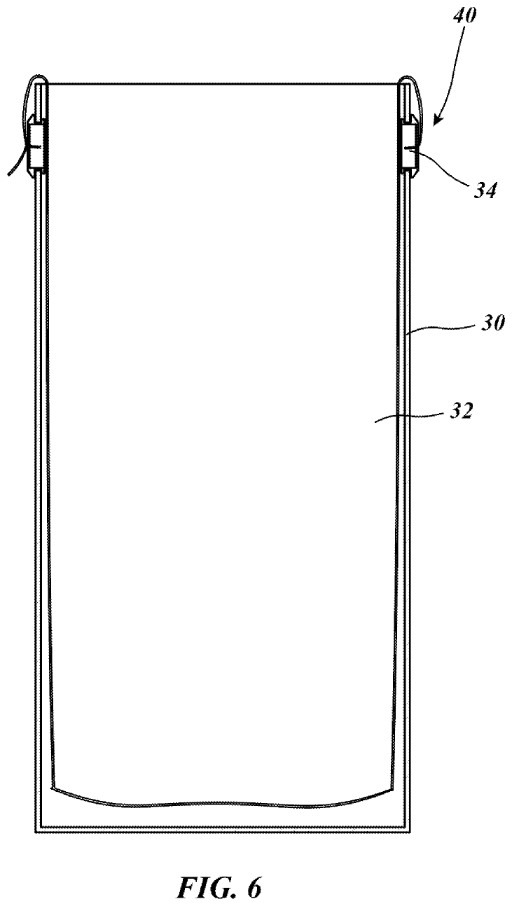

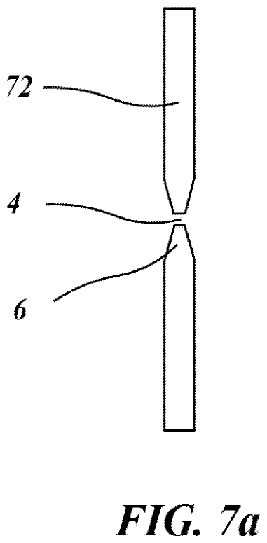

FIG. 4 through 6, shows another embodiment of a bag gripper shown generally at 40. The bag gripper 40 can comprise a side wall 14 having a groove 52, and the back wall having a hole 58. The hole's 58 perimeter aligning with the interior surface 13 of the side wall. The groove 52 defines two surfaces, a first surface 54 and a second surface 56. In this embodiment the bag gripper 40 can be inserted into a hole on one or more locations on the can 30. The bag gripper 40 can be attached to the trash 30 through the hole by the first surface 54 and the second surface 56 wherein the first surface and second surface can sandwich the walls of the can, securing the bag gripper 40 to the can preventing the bag gripper from falling into the refuse and from getting lost as shown in FIG. 8. In certain embodiments, the bag gripper 40 can have adhesive 18 on one of the first surface 54 or the second surface 56 or both surfaces. The adhesive 18 can be a glue, tape, polyimide, epoxy, polyurethane, paste, liquid, film, or the like. The adhesive 18 can have a removable backing 19 to protect the adhesive before it is attached to the can 30 or another object. The hole 58 in the back wall allows for the excess liner to be pulled tight around the can, through the slits 8, and into the interior of the trash can 30.

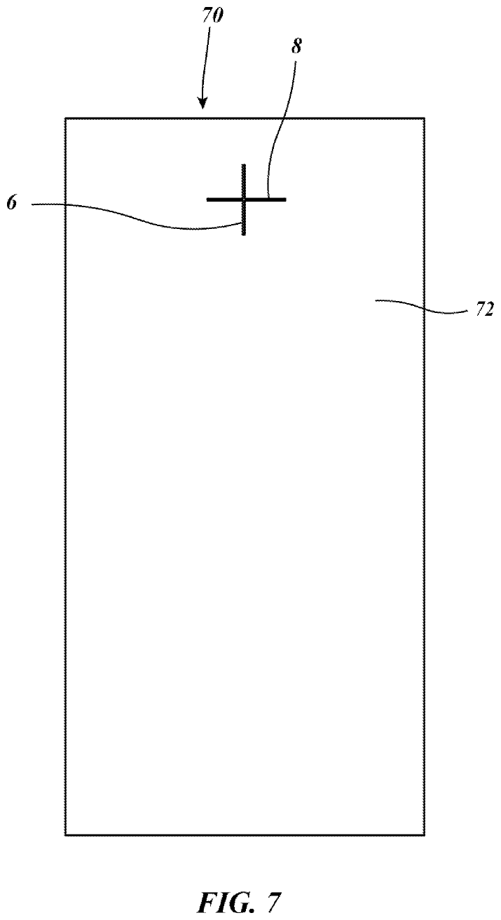

FIGS. 7-7a, shows another embodiment in which the bag gripper is integrated within the trash can, shown generally at 70. In this embodiment the side wall 72 of the trash can 70 has two slits 8 which intersect at an intersection point 4, and which define four tabs 6. The bag gripper here can have one or more slits, which in turn can define more or fewer tabs. The intersection point 4 can be in the approximate center of the slits, or it can be off-centered towards one end, or a combination of centered and off-centered. The can 70 can be manufactured such that the tabs 6 are thinner than the rest of the side wall 72, narrowing from the side wall 72 to the intersection point 4. This allows the tabs 6 to be more flexible and less rigid which makes it easier to insert a trash can liner 32. The tabs can be configured to grip a thin material, such as, for example, a trash can liner, fabric, sheet of plastic, plastic bag, small rope, and the like. In this embodiment the excess liner is pulled through the slits and into the interior of the can 30. The can 72 can be manufactured from such as, for example, flexible and durable materials such as rubber, nylon, plastic, or the like.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. A bag gripper to secure a bag to a container having an outer surface, the bag gripper comprising:
a body having a back wall that is attachable to the outer surface and a front wall wherein the front wall and the back wall are coupled together by at least one side wall forming a hollow chamber; and
the front wall having at least one slit defining at least two tabs.

2. The bag gripper of claim 1, wherein the front wall has at least two slits that intersect at an intersection point, defining at least four tabs.

3. The gripper of claim 2, wherein the substantial center of the at least two slits intersect in the substantial center of the front wall.

4. The gripper of claim 1, wherein the back wall exterior has an adhesive.

5. The gripper of claim 4, wherein the adhesive has a removable backing.

6. The gripper of claim 1, wherein the back wall has a hole, the hole perimeter aligning with the interior of the side wall.

7. The gripper of claim 1, wherein the side wall further comprises a groove with a first surface and a second surface.

8. The gripper of claim 7, wherein the first surface and second surface have an adhesive

9. The gripper of claim 1 wherein the front wall is made of flexible and durable materials

10. The gripper of claim 9, wherein the flexible and durable materials are rubber, nylon, or plastic

11. A container to accommodate a bag, the container comprising:
a bag gripper having a body with a front wall, a back wall, and at least one side wall defining a hollow chamber;
wherein the front wall has at least one slit defining at least two tabs and the side wall comprises a groove having a first surface and a second surface; and the back wall having a hole wherein the perimeter of the hole aligns with the interior of the
side wall; and
wherein the at least one bag gripper is attached to the at least one side of the can over the at least one hole in such a way that the at least one side of the can is sandwiched between the first and second surfaces.

12. The can of claim 11, wherein the front wall has at least two slits that intersect at an intersection point, defining at least four tabs.

13. The can of claim 12, wherein the substantial center of the at least 2 slits intersect in the substantial center of the front wall.

14. The can of claim 15, wherein the front wall is made of flexible and durable materials.

15. The can of claim 14, wherein the flexible and durable materials are rubber, nylon, or plastic.

16. A container for accommodating a bag, the container comprising:
a can with a bottom and at least one side;
wherein the at least one side contains at least two slits which intersect at an intersection point;
wherein the at least two slits define at least four tabs
wherein the at least four tabs narrow from the side wall to the intersection point

17. The can of claim 16 wherein the at least one can side is made of flexible and durable materials.

18. The can of claim 17, wherein the flexible and durable materials are rubber, nylon, or plastic.
